(19) United States
(12) Patent Application Publication
(10) Pub. No.: US 2016/0093871 A1
(43) Pub. Date: Mar. 31, 2016

(54) A LITHIUM-ION SECONDARY BATTERY WITH REPLACEABLE ELECTRODES

(71) Applicant: Dahe LI, Beijing (CN)

(72) Inventor: Li Dahe, Beijing (CN)

(21) Appl. No.: 14/889,152

(22) PCT Filed: Jul. 15, 2013
(86) PCT No.: PCT/CN2013/079424

§ 371 Date: Nov. 5, 2015

(30) Foreign Application Priority Data
Jun. 19, 2013 (CN) 201310243731.4

(51) Int. Cl. H01M 2/36; H01M 2/12; H01M 10/0525

(52) U.S. Cl. CPC H01M 2/364; H01M 10/0525; H01M 2/362; H01M 2/361; H01M 2/1223

(57) ABSTRACT

A li-ion battery with replaceable electrodes is provided. The battery compromises operation space to make the electrode sheets replaceable and side chamber to vent electrolyte through electrolyte pipeline for stopping reactions inside the battery.

### CLAIM OF PRIORITY

The present application claims priority from Chinese application 201310243791.4 filed on Jun. 19, 2013, the content of which is hereby incorporated by reference into this application.

### FIELD

This invention relates to a li-ion battery and more particularly to a li-ion battery with replaceable electrodes.

### BACKGROUND

Current li-ion battery has positive electrodes, separators and negative electrodes stacked or wounded in direct contact. The separators, soaked with electrolyte, together with positive electrodes and negative electrodes form a complete electrochemical system. The battery is usually disposed when it reaches the end of life. Positive electrode and negative electrode have different aging rate and cycle life, and the life of the battery is determined by the electrode with shorter life, so the electrode with longer life is not fully utilized. The recycle of waste li-ion battery is not wide-spread at present; therefore, the battery structure that positive electrodes, separators and negative electrodes are in direct contact could lead to a waste of some electrode materials.

The separator is soaked with electrolyte which could not be vented in current battery structure. When there is thermal-runaway in the battery, internal pressure will increase and result in some accidents. Some li-ion batteries are able to vent the gas inside when the pressure reaches certain limit. However, the gas contains many combustibles which could also cause accidents.

### SUMMARY

In accordance with one embodiment, this invention provides a li-ion battery compromising replaceable electrode sheets which have operation space between each other, electrolyte pipeline and side chamber to vent and hold the electrolyte.

### BRIEF DESCRIPTION OF THE DRAWINGS

FIG. 1 shows the structure of a li-ion battery with replaceable electrodes.

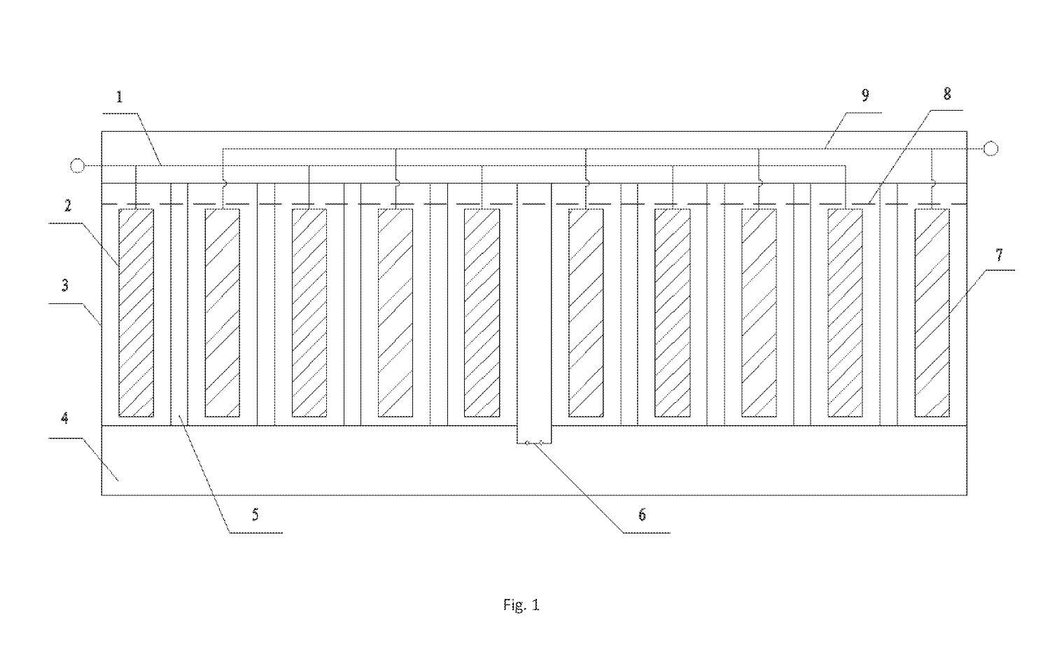

FIG. 2 shows the change of the battery when the electrolyte pipeline is open and the electrolyte is vented to side chamber.

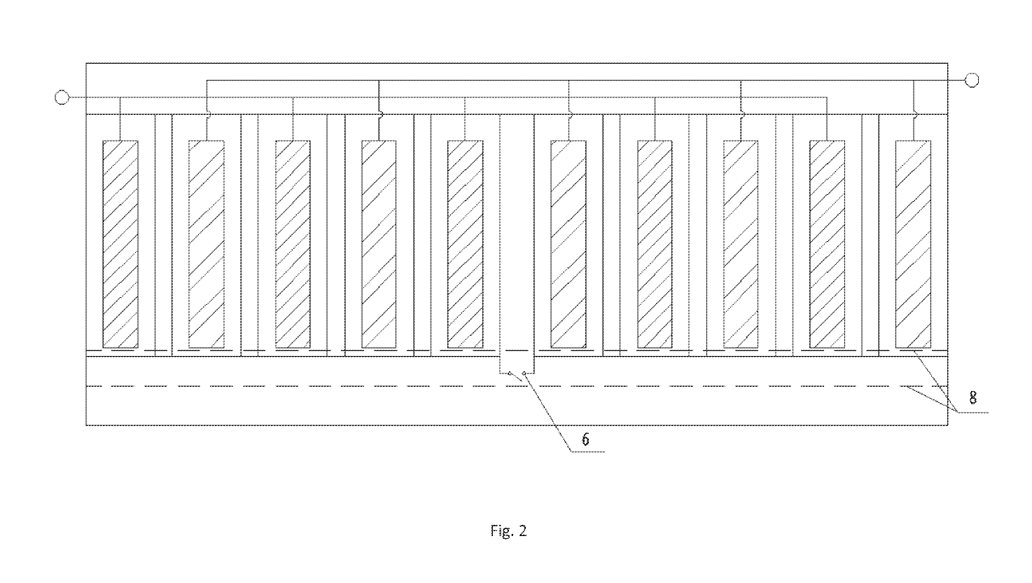

### DESCRIPTION

For better understanding of the invention, the embodiment will be illustrated and described with the drawings. It should be noted that no limitation to the scope of the invention is intended.

Current li-ion battery secondary battery usually has negative electrode of graphite or Li₄Ti₅O₁₂ material, and positive electrode of LiMn₂O₄, Li(NiₓCo_{y}Mn_{z})O₂ (0<x<1, 0<y<1, 0<z<1, x+y+z=1) or LiFePO₄. Graphite negative electrode and LiFePO4 positive electrode will be taken as an example.

Container 3 contains all components; positive electrode sheets 2 are connected to positive electrode terminal 1, negative electrode sheets 7 are connected to negative electrode terminal 9, and all electrode sheets are under electrolyte surface 8; operation space 5 is between electrode sheets and filled with electrolyte; electrolyte pipeline 6 controls the connection of operation space 5 and side chamber 4.

Negative electrode sheet 7, operation space 5 and positive electrode sheet 2 are arranged in container 3, and separated by porous plate which the electrolyte is able to get through. Electrode sheets are separable from electrode terminals without affecting adjacent sheets because of operation space 5. LiFePO₄ has more stable structure and less side reactions than graphite, therefore, the negative electrode has higher aging rate. The life of the battery is also over when the negative electrode reaches the end of life, but the positive electrode is still usable. In this case the battery could be discharged to lower voltage limit and get negative electrode sheets replaced. After refilling electrolyte, precharge and formation the battery could work again. The capacity would be lower than before. The negative electrode sheets could be replaced for at least 3 times.

If there is thermal-runaway in actual use, the electrolyte pipeline 6 will open when internal pressure reaches predefined limit, and the electrolyte in operation space 5 will be vented to side chamber 4 until electrolyte surface 8 is lower than all electrode sheets. The electrochemical reactions in the battery are stopped to prevent the increase of internal pressure.

What is claimed is:

1. A li-ion battery compromising positive electrode terminal, positive electrode sheets separable from positive electrode terminal, negative electrode terminal, negative electrode sheets separable from negative electrode terminal, operation space to replace electrode sheets, electrolyte, electrolyte pipeline to vent electrolyte, side chamber to hold the electrolyte vented.

2. The li-ion battery of claim 1, wherein the electrode sheets in the container are separated by operation space.

3. The li-ion battery of claim 1, wherein the operation space is connected to electrolyte pipeline.

4. The li-ion battery of claim 1, wherein the electrolyte pipeline is driven by the electrolyte.

5. The li-ion battery of claim 1, wherein the electrolyte in operation space is vented under the pressure difference of the container and the side chamber.
